(19) United States
(12) Patent Application Publication
(10) Pub. No.: US 2025/0165562 A1
(43) Pub. Date: May 22, 2025

(54) SYSTEMS AND METHODS FOR EVALUATING NATURAL LANGUAGE PROCESSING MODELS

(71) Applicant: Royal Bank of Canada, Toronto (CA)

(72) Inventors: MohammadHosein AhmadiDaneshAshtiani, Richmond Hill (CA); Amin Omidvar, North York (CA); Satish Shankar Silveri, Toronto (CA); Moamen Abdelrazek, Calgary (CA); Emad Jabbar, Calgary (CA); Daniel Foisy, Pickering (CA); Heathcliff Lewis, Oakville (CA)

(21) Appl. No.: 18/940,246

(22) Filed: Nov. 7, 2024

Related U.S. Application Data
(60) Provisional application No. 63/600,561, filed on Nov. 17, 2023.

(51) Int. Cl. G06F 18/2415; G06F 40/40; G06N 20/00

(52) U.S. Cl. CPC G06F 18/2415; G06F 40/40; G06N 20/00

(57) ABSTRACT

Methods, systems, and techniques for evaluating natural language processing models are disclosed. A method of evaluating natural language processing models comprises: obtaining a dataset for a particular application comprising a plurality of data pairs; applying the plurality of data pairs to each of a plurality of natural language processing models, wherein each of the plurality of natural language processing models outputs respective embedding representations of the plurality of data pairs; classifying the respective embedding representations of the plurality of data pairs output from each of the plurality of natural language processing models using a classifier trained to classify the data pairs; and comparing classification results of the classifier on the respective embedding representations of the data pairs output from each of the plurality of natural language processing models to evaluate the plurality of natural language processing models for the particular application.

### CROSS-REFERENCE TO RELATED APPLICATIONS

This application claims priority to U.S. Provisional Patent Application No. 63/600,561, filed on Nov. 17, 2023, the entire contents of which is incorporated herein by reference for all purposes.

### TECHNICAL FIELD

The present disclosure is directed at methods, systems, and techniques for evaluating natural language processing models.

### BACKGROUND

Since the introduction of transformer encoder models (e.g., BERT, SBERT, etc.), usage of state-of-the-art natural language processing (NLP) models is growing rapidly in various artificial intelligence (AI) applications. Companies are looking to use AI in a variety of customer and employee touchpoints and are using NLP models in a wide range of applications. However, given the ever-increasing number of NLP models, it can be hard for developers to know which model to select for their particular application. For the sake of expediency, developers often choose a model that they feel provides a satisfactory performance, although they are unable to quantify the performance and it may be in fact be sub-par relative to other available NLP models.

### SUMMARY

According to a first aspect, there is provided a method of evaluating natural language processing models, comprising: obtaining a dataset for a particular application comprising a plurality of data pairs; applying the plurality of data pairs to each of a plurality of natural language processing models, wherein each of the plurality of natural language processing models outputs respective embedding representations of the plurality of data pairs; classifying the respective embedding representations of the plurality of data pairs output from each of the plurality of natural language processing models using a classifier trained to classify the data pairs; and comparing classification results of the classifier on the respective embedding representations of the data pairs output from each of the plurality of natural language processing models to evaluate the plurality of natural language processing models for the particular application.

In some aspects, the method further comprises generating the dataset comprising positive and negative data pairs by: receiving a sample dataset comprising unlabelled sample data; generating positive and negative data pairs from the sample dataset.

In some aspects, the sample dataset comprises sample data pairs, and wherein generating the positive data pairs from the sample dataset comprises labelling received sample data pairs as positive data pairs, and generating negative data pairs from the sample dataset comprises generating a negative output for a respective input. Generating the negative input for the respective output may comprise one or more of: randomly generating the negative output by picking a random output from the data set for the respective input, where an identifier of the random output and the respective input are different; randomly choosing an output for the respective input, calculating a topic vector for the output and the respective input, and selecting the output as the negative output for the respective input when the topic vectors are not equal; and randomly choosing an output for the respective input, calculating a cosine similarity of the output and the respective input, and selecting the output as the negative output for the respective input when the cosine similarity is less than a threshold.

In some aspects, the sample dataset comprises non-paired input data, and generating the positive and negative data pairs comprises determining clusters of output data for a respective input, and determining positive and negative outputs for the respective input from the clustering analysis.

In some aspects, the method further comprises splitting the dataset into training data, validation data, and test data, wherein the training data and the validation data are used for training the classifier.

In some aspects, the respective embedding representations of the plurality of data pairs comprise embedding representations generated by different pooling strategies of a same natural language processing model.

In some aspects, the respective embedding representations of the plurality of data pairs comprise embedding representations output by different layers of a same natural language processing model.

In some aspects, the method further comprises extracting features from the embedding representations of the plurality of data pairs for performing the classification, the extracting comprising one or more feature extraction methods selected from: concatenating the embedding vectors for each data pair; multiplying the embedding vectors for each data pair; subtracting the embedding vectors for each data pair; concatenating and multiplying the embedding vectors for each data pair; concatenating and subtracting the embedding vectors for each data pair; concatenating and subtracting and multiplying the embedding vectors for each data pair; and subtracting and multiplying the embedding vectors for each data pair.

In some aspects, classifying the respective embedding representations of the plurality of data pairs is performed using different feature extraction methods from the same respective embedding representations.

In some aspects, the classifier is a weak classifier.

In some aspects, the method further comprises generating an ensemble model of embedding vectors generated from the embedding representations of the plurality of data pairs output from each of the plurality of natural language processing models.

In some aspects, generating the ensemble model of embedding vectors comprises using a neural network that determines weights for combining the plurality of natural language processing models.

In some aspects, generating the ensemble model of embedding vectors comprises: normalizing each of the embedding representations of the plurality of data pairs output from each of the plurality of natural language processing models; building an ensemble embedding vector by concatenating the normalized embedding representations from a respective natural language processing model; and calculating the similarity of the embedding representations output from different natural language processing models by calculating a dot product between corresponding ensemble embedding vectors.

In some aspects, generating the ensemble model of embedding vectors comprises: converting the embedding representations of the plurality of data pairs generated by each transformer encoder model into a feature vector using multiplication; combining the feature vectors; and providing the combined feature vectors to a multi-head attention network.

In some aspects, the method further comprises receiving a configuration file that specifies parameters used in the evaluation of the natural language processing models.

According to a second aspect, there is provided a system for evaluating natural language processing models, comprising: a processor; and a non-transitory computer-readable medium having computer-executable instructions stored thereon which, when executed by the processor, configure the system to perform the method of evaluating natural language processing models as claimed in any one of the above aspects.

According to a third aspect, there is provided a non-transitory computer-readable medium having computer-executable instructions stored thereon which, when executed by a processor, configure the processor to execute the method for evaluating natural language processing models as claimed in any one of the above aspects.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a computer network that comprises an example embodiment of a system for evaluating natural language processing (NLP) models;

FIG. 2 is a block diagram of a server comprising part of the system depicted in FIG. 1;

FIG. 3 depicts an example flow chart for evaluating embedding quality from NLP models;

FIG. 4 depicts a graph comparing model accuracy;

FIG. 5 depicts a graph comparing feature engineering approaches for a given transformer model;

FIG. 6 depicts a graph comparing pooling strategies for a given transformer model.

FIG. 7 depicts a graph showing the effect of extracting embedding vectors from different layers of a given transformer model.

FIG. 8 depicts an example flow chart of a first ensemble architecture;

FIG. 9 depicts an example flow chart for building a similarity matrix;

FIG. 10 depicts an example flow chart for building ensemble models;

FIG. 11 depicts an example flow chart implemented by an evaluator module;

FIG. 12 depicts a graph showing improvements in accuracy between different models;

FIG. 13 depicts a graph showing improvement on acc@5 of different combinations of ensemble models relative to the best single model;

FIG. 14 depicts a graph showing how learning weights by a neural network could improve the result compared to an equal-weighting approach;

FIG. 15 depicts a graph showing the performance of the base, fine-tuned, and ensembles relative to the worst model;

FIG. 16 depicts a representation of the embedding vectors being combined with a second architecture;

FIG. 17 depicts a representation of the dot product between two ensemble embedding vectors;

FIG. 18 depicts a representation of the embedding vectors being combined with a third architecture;

FIG. 19 depicts a method of evaluating natural language processing models in accordance with the present disclosure; and

FIGS. 20A-D shows examples of charts generated in training the weights for the ensemble models.

### DETAILED DESCRIPTION

Transformer encoder models (e.g., BERT, SBERT, etc.) have a wide range of applications in various NLP downstream applications. However, these models are trained based on different pre-training tasks and on different datasets, which causes them to differ from each other in terms of performance metrics on different tasks. It has been observed that for NLP models, the utility of the model for a given application or use-case depends on the data that the NLP model was trained on as well as the pre-training tasks. Pre-trained language models are often trained to perform well on industry benchmarks. Since there are so many models available, finding the right model to use for a particular application is not only time consuming but also difficult to do and requires deep technical expertise. More and more open source and vendor-based models appear in the market that claim superior capabilities, however, findings and recent research on benchmarks show that the models will perform different depending on the use case. Accordingly, while pre-trained language models may be evaluated/ranked against industry benchmarks based on their performance using certain labelled data, it will be appreciated that companies often have unique datasets and applications of language models, and the pre-trained language models may not perform well on specific use-cases, particularly when using few shot training. What is needed is an automated approach to evaluate pre-trained models for a particular use case with a unique dataset.

In accordance with the present disclosure, an NLP software development kit (SDK) is disclosed to assist NLP practitioners evaluate and choose an open source language model for their specific application based on performance of the model evaluated using data native to the application. The tool will save valuable time and effort for developing applications to perform language processing tasks like search, classification, clustering, similarity analysis, response recommendation, translation, etc., by optimizing the discovery and application of the best text representation given from a language model and/or other NLP techniques. The NLP SDK expedites the process of picking the right model based on a variety of factors including application data, pre-training tasks, and architecture of the model itself. Accordingly, developers are provided with a means of evaluating and selecting the right NLP model for the specific use case.

Further, the NLP SDK in accordance with the present disclosure can also find the best combination of models and data to increase the output performance further, i.e. by creating an ensemble model that may perform significantly better than any individual model. Also, the architecture would not only allow to improve the accuracy of downstream NLP applications, but also optimize them without making systems slower.

The NLP SDK may also create recommendations to application developers using language models across a company, thus allowing for the creation and maintenance of curated models inside companies which can be reused across multiple applications through a search and discovery process similar to knowledge articles today.

In at least some embodiments herein, methods, systems, and techniques for evaluating natural language processing models are disclosed. A method of evaluating natural language processing models comprises: obtaining a dataset for a particular application comprising a plurality of data pairs; applying the plurality of data pairs to each of a plurality of natural language processing models, wherein each of the plurality of natural language processing models outputs respective embedding representations of the plurality of data pairs; classifying the respective embedding representations of the plurality of data pairs output from each of the plurality of natural language processing models using a classifier trained to classify the data pairs; and comparing classification results of the classifier on the respective embedding representations of the data pairs output from each of the plurality of natural language processing models to evaluate the plurality of natural language processing models for the particular application.

More particularly, the systems and methods of evaluating natural language processing models disclosed herein can be performed using state-of-the-art NLP libraries and resources that enable the following:

Model Benchmarking. The systems and methods of evaluating natural language processing models disclosed herein provide a means to receive unlabeled text data as input (e.g., question answering, conversation data, emails, incident description, etc.) and evaluate different types of state-of-the-art natural language processing models transformer-based embeddings across different evaluation metrics such as Area under Receiver Operating Characteristic Curve (AUC), Mean Reciprocal Rank (MRR), Precision, etc. This way, data scientists and application developers can benchmark the best natural language processing model that works best with their specific data for different downstream NLP applications. Natural language processing model selection can be made for each specific use case and thus the evaluation is fit-for-purpose based on the use case and specific application data.

Model A/B Testing. The systems and methods of evaluating natural language processing models disclosed herein provide a set of top model recommendations for NLP application developers using well-defined benchmarks, taking any guesswork out of the equation when developing new applications. Evaluations may also include manual monitoring of existing deployed models for performance drift and recommending improvements based on the scores received per model.

Language model embedding selection. The systems and methods of evaluating natural language processing models disclosed herein provide a means of evaluating embeddings quality for sophisticated language models. As the size of language models grow, the embeddings of these models are of increasing value for a variety of natural language applications. The NLP SDK tool disclosed herein allows application developers to find the embeddings that work best for a combination of application training data, model architecture and pre-training tasks for the specific language model.

An architecture to select ensemble text representation. In addition to selecting the best fit natural language processing model embedding, the systems and methods of evaluating natural language processing models disclosed herein enables selection of the best ensemble representation using an information retrieval benchmark. It is often found that the ensemble representation significantly outperforms any single embedding. The combination of pre-trained embeddings and in-domain text representation are possible and in many cases result in significantly higher performance.

Ease of use and reuse for configurations. The NLP SDK tool enables reuse of algorithms by developers and data scientists through easily configuring and reconfiguring a configuration template for different NLP tasks.

Accordingly, the systems and methods of evaluating natural language processing models disclosed herein provides an automated pipeline to evaluate and recommend the best natural language processing models and optionally their ensemble configuration for a given NLP application having a particular dataset and use case. The benchmarks, dataset, and evaluation pipeline allows companies to select the best available model(s) and vendors to onboard the most effective, safe, and scalable adoption.

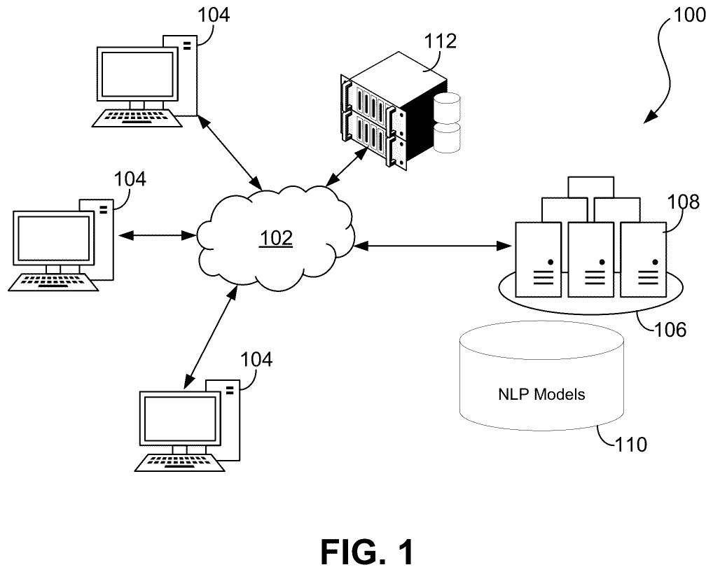

Referring now to FIG. 1, there is shown a computer network 100 that comprises an example embodiment of a system for evaluating natural language processing models. More particularly, the computer network 100 comprises a wide area network 102 such as the Internet to which various user devices 104, and data center 106 are communicatively coupled. The data center 106 comprises a number of servers 108 networked together providing a NLP SDK and collectively perform various computing functions for evaluating natural language processing models. The NLP models may be stored in database 110 accessible by the servers 108. The NLP models stored in the database 110 on which the evaluation is performed may be obtained over the network 102 from one or more third party servers (e.g. vendor servers providing open-source NLP models). Additionally, NLP models on which the evaluation is performed may be obtained from one or more of the user devices 104, which may have developed and/or be running customized NLP models.

The servers 108 may provide an interface (e.g. a user interface platform) to interact with the user devices 104, which may be operated by software developers and/or data scientists. A configuration file may be sent from a user device(s) to the servers 108 to instruct the servers 108 to evaluate NLP models. For the sake of example, the configuration file may be written in json, and defines a location from which input data can be retrieved to perform the analysis, as well as defines preprocessing, topic modelling training, and generation embedding inference to manage the machine learning workflow, and allows for tuning hyperparameters of the models to be evaluated. Key features of the configuration file may include:
Preprocessing Parameters: a user can define the steps for text cleaning, tokenization, stop-word removal, stemming or lemmatization, and other preprocessing techniques.

Topic Modelling Parameters: a user can specify the type of topic modelling algorithm (like Latent Dirichlet allocation (LDA), Non-negative Matrix Factorization (NMF)), the number of topics, and other model-specific parameters.

Training Parameters: training parameters include settings like the number of epochs, batch size, learning rate, and optimization algorithm for the topic modelling training phase.

Embedding Generation Parameters: a user can control the type of model embeddings used for inference, their dimensions, and other related parameters.

Embedding evaluation: a user can decide on which step of the pipeline to invoke the capability to evaluate embeddings and run experiments.

Ensemble creation and evaluation: a user can define what combination of the models to be evaluated so one can choose and use them as part of its final solution.

Fine-Tunning module: a user can configure the models that will be finetuned with data processed by previous modules.

The configuration file acts as a comprehensive control center for the NLP pipeline, and ensures reproducibility of experiments and enhances efficiency by centralizing all settings. Accordingly, a configuration file provides a configurable, low code template that software developers can modify and upload to the servers 108 for performing model evaluations. The configuration file and server interface thus provides the system with modularity and ease of use for software developers.

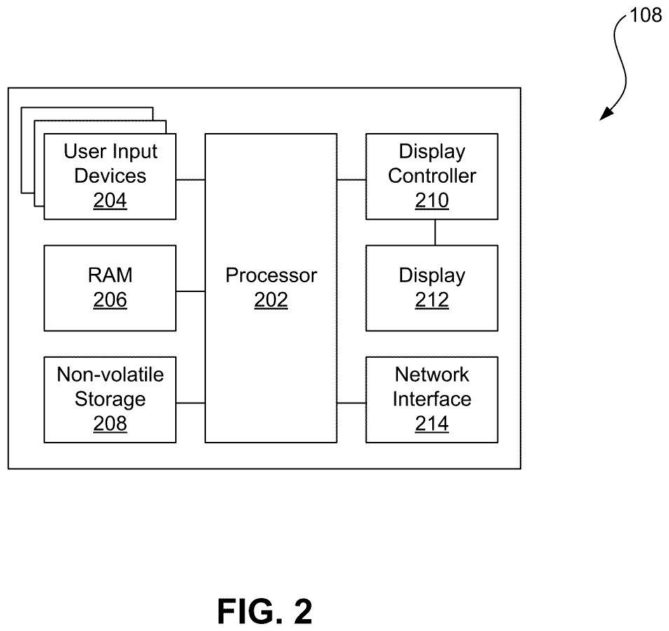

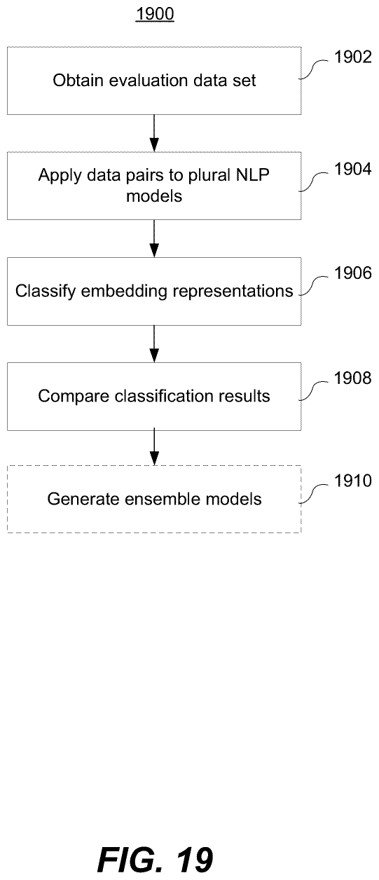

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for evaluating natural language processing models such as is described in more detail in respect of FIG. 19 below. Additionally or alternatively, the servers 108 may collectively perform that method using distributed computing. While the system depicted in FIG. 2 is described specifically in respect of one of the servers 108, analogous versions of the system may also be used for the user devices 104.

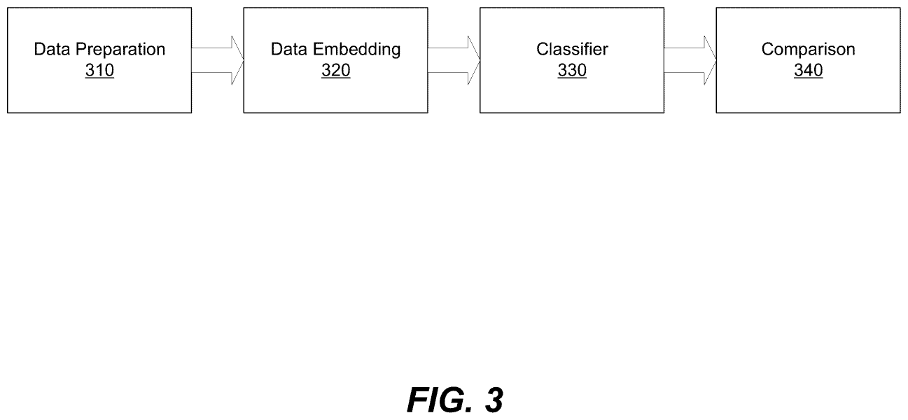

FIG. 3 depicts an example flow chart for evaluating embedding quality from NLP models. The goal of evaluating embedding quality is to determine the quality of the generated embedding vectors from natural language processing models such as transformer models on case-specific data. By having appropriate methods and metrics to determine the quality of embedding vectors, the models that perform best for the specific use case can be employed.

Further, as described below, the method of evaluating embedding quality may also be used to investigate how different types of feature engineering techniques and pooling strategies impact the quality of the downstream NLP task, thus ensuring that the best approach is selected for each specific model.

In addition, as described below, the method of evaluating embedding quality may also be used to investigate model performance by extracting the embedding vectors from other layers rather than the last layer and find out how the result would be different based on different datasets, models, and pooling methods.

The NLP SDK implements a pipeline to evaluate the quality of embedding vectors generated by natural language processing models for text data and determines the best embedding vectors, and optionally feature extraction strategy and embedding extraction layer, to increase the performance of a given downstream NLP application. A classifier, and in particular embodiments, a weak classifier, is used to assess the quality of the embedding vectors. A dashboard may be presented in a user interface that provides a detailed comparison between different models in terms of evaluation metrics. As seen in FIG. 3, the architecture of the pipeline for evaluating embedding quality from NLP models encompasses four stages as is shown in FIG. 3: Data Preparation 310, Data Embedding 320, Classifier 330, and Comparison 340.

In the data preparation stage 310, input data is split into train, validation, and test sets based on specified proportions. For each set, if the data does not have labels, a negative sampler is used to generate labels by converting the data into positive and negative samples. Creating positive and negative samples from the data is very useful when there are no supervised data sources (labelled data does not exist), which is often the case for the datasets that companies have available.

The received dataset is for a particular application. In some examples, the received dataset may comprise question-and-answer (QA) pairs, conversation data, call center data, search queries and feedback, FAQs, etc. In some instances, the data may be received as pairs (e.g. QA pairs). In other instances, the data pairs may be defined according to a pairing strategy depending on the objective. For example, consider conversational data that comprises a series of conversations between two parties. In these situations, the pairing strategy may involve, for example: (a) party 1 as column 1 and party 2 as column b; (b) party 1 and a set of labels representative of party 1's points as column 1 and party 2 and corresponding set of labels as column 2; or (c) party 1 and party 2 as column 1 and a set of labels representing the conversation as column 2. Other types of data pairs can be defined for other types of input data. For example, Search Queries Data may comprise a search query plus a set of recommended articles plus (in some cases) what the user clicked on plus (in some cases) user feedback; Email Data may comprise an email chain with multiple parties; Calls Data may comprise a transcription of calls between two or three parties; Documents may comprise documents (e.g., invoices, legal documents, . . . ) plus (in some cases) class labels plus (in some cases) entity labels from the document. Accordingly, it will be appreciated that question and answer datasets may not require processing to generate data pairs, while other datasets will be converted to pairs, where the conversion depends on the objective of modeling. For example, if the user is trying to understand what type of invoice is provided in an email attachment for an email management use case, the type or types would be the second pair e.g., the text of invoice is pair 1 and array of labels are pair 2. That is, for each type of data provided above and based on the modelling objective, different pairing strategies will be used.

Some of these data pairs may be labelled. For example, all current QA pairs can be labelled as positive data pairs. The negative sampler component is used to generate negative samples. To generate the negative samples from labelled data pairs, the negative sampler may perform one or more of the following strategies (described in the context of QA pairs for the sake of example):

(1) Random: The negative sampler will create the negative samples by picking N random answers from the corpus for each question. The only condition is that the question's ID and the chosen answer's ID should be different.

(2) Topic: An answer is chosen randomly for each question. Then topics of each question-and-answer pair are extracted from their topic vectors that are calculated by Non-Negative Matrix Factorization (NNMF) method. If their topics are not equal it would be a valid negative sample, otherwise, this process would be repeated by picking another random answer.

(3) Semantic: An answer is chosen randomly for each question. The cosine similarity of the question and the chosen answer is calculated. If the similarity is less than the threshold, the negative sample is valid, otherwise, this process would be repeated by picking another random answer.

It has been found that the generation of negative samples using the different methods above did not produce significantly different results in evaluating the quality of embedding vectors. As it is important to ensure that the sample set is a good representation of the use case, an evaluation may be performed using data generated by all three negative sampling techniques. Alternatively, a user of the NLP SDK may also be provided with the ability to select one or more negative sampling methods (e.g. by specifying such in the configuration file). Additionally, it will be appreciated that other techniques for negative sampling may be used or become available.

In other instances, the received dataset may be non-paired and unlabeled. In this case, generating the positive and negative data pairs may be performed by determining clusters of output data for a respective input, and determining positive and negative outputs for the respective input from the clustering analysis. For example, positive data pairs may be generated by selecting an output from a positive cluster of outputs for a given input. Negative data pairs may be generated by selecting an output from outside the positive cluster of outputs for a given input. As an example, consider a case where non-paired data without labels comprises a list of queries that users send to a search engine. The SDK clusters the data into different clusters, and then based on the number of samples desired, each sample is paired with a cluster that belongs to the same topic as a positive pair, and with a cluster from another topic as a negative pair.

In the data embedding stage 320, different NLP models are employed to convert the data into their embedding representation.

For SBERT models, for example, since they are optimized directly to provide a semantic representation of the text, the default configuration of the models is followed to extract the embeddings. That means the calculated embedding vectors would be only based on the last layer and the default pooling method of that particular model. However, for other transformer encoders models such as BERT, the embedding representation of the data may be extracted based on different pooling strategies for different layers as follows:

CLS token: only the embedding representation of the CLS token is extracted.

avg_pool_with_cls: Average of the embedding representations of all available tokens (i.e., token's mask is True).

avg_pool_without_cls: Average of the embedding representations of all available tokens excluding CLS token.

max_pool_with_cls: Applying max pool operation on embedding representations of all available tokens (i.e., token's mask is True).

max_pool_without_cls: Applying max pool operation on embedding representations of all available tokens excluding CLS token.

Further, feature engineering may be applied to the embedding vectors of the positive and negative data pairs for input into the classifier stage 330 based on one or more of the following approaches:

Cat: It's a concatenation of the embedding vectors.

Mul: It's a multiplication of the embedding vectors.

Sub: It's an absolute value of a subtraction of the embedding vectors.

CatMul: It's a concatenation of Cat and Mul strategies.

CatSub: It's a concatenation of Cat and Sub strategies.

CatSubMul: It's a concatenation of Cat, Mul, and Sub strategies.

SubMul: It's a concatenation of Sub and Mul strategies.

The classifier stage 330 receives the extracted features from the previous stage and applies them to the classifier. In some embodiments, a weak classifier may be used such that the quality of the input features could have significant effect on the performance of the classifier. One reason for using the weak classifier is to ensure the accuracy being evaluated depends only on the quality of the embedding vectors and that a minimum amount of time and computing resources is used to detect the best pre-trained language model Therefore, a better comparison is obtained between different input features from the previous stage, with minimal computational expense. As an example, a perceptron may be used as the weak classifier, but it could be replaced with other types of classifiers as well. The weak classifier is trained on the training set and evaluated based on different metrics such as accuracy, Area under the ROC Curve (AUC), etc., on the test set. The task is to perform binary classification to determine whether the pairs are matched or not (i.e. whether the data pairs are positive or negative), so for that purpose, binary cross entropy loss function is used. Detailed reports of the training may be output so that users can ensure the models are trained effectively and/or for debugging purposes. For example, separate charts for loss function, precision, recall, and f1-score over training steps (epochs) may be generated and output.

In the comparison stage 340, the evaluation results of how the classifier performed on the embedding vectors generated from different models are aggregated for comparison. The evaluation results may be output and presented in a performance dashboard in a user interface of the tool. This evaluation not only helps users to find the best models for a specific use case, but also how to select the best options (i.e., poolings, feature extraction methods, and layers) for each model to achieve the best results.

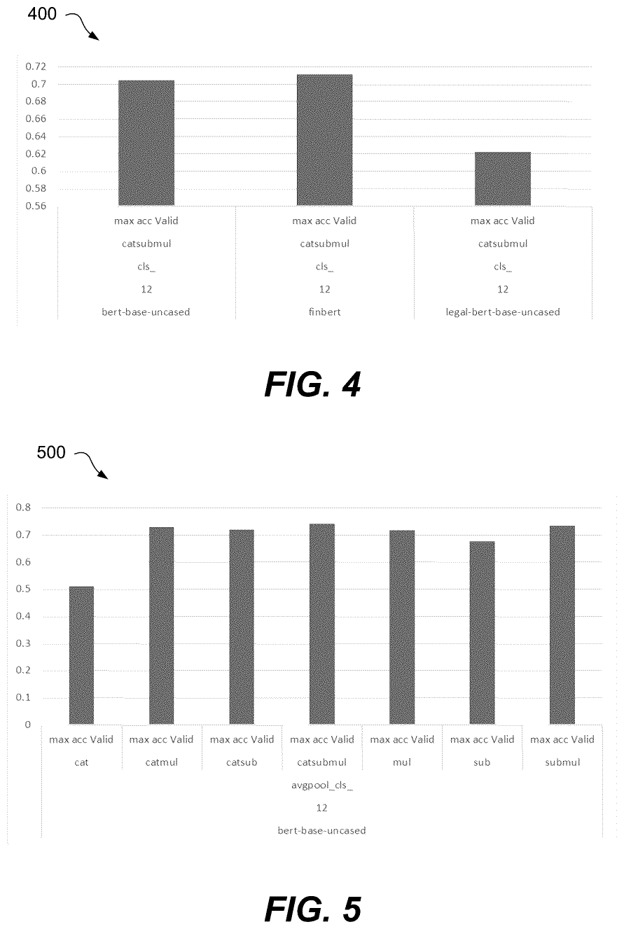

For example, FIG. 4 depicts a graph 400 comparing model accuracy. The models being compared are different BERT (Bidirectional Encoder Representations from Transformers) models (bert-base-uncased, finbert, and legal-bert-base-uncased), where the embedding vectors were extracted from the CLS token in layer 12, and CatSubMul feature engineering was applied. The graph 400 shows that there is a significant difference in accuracy performance between the different BERT models on this particular Question and Answer validation data set.

FIG. 5 depicts a graph 500 comparing feature engineering approaches for a given transformer model. In this analysis, different feature engineering approaches (cat, catmul, catsub, catsubmul, mul, sub, submul) were applied to embedding representations generated from a bert-base-uncased model, where the embedding representations were the average of the embedding representations of all available tokens (avgpool_cls) extracted from layer 12. As seen in the graph 500, there is a significant difference in accuracy performance of the model based on how the embedding features are generated. The worst approach in this case is the method where the embedding vectors are concatenated together (i.e., cat) and the best approach is using the three feature extraction strategies together (i.e., catsubmul).

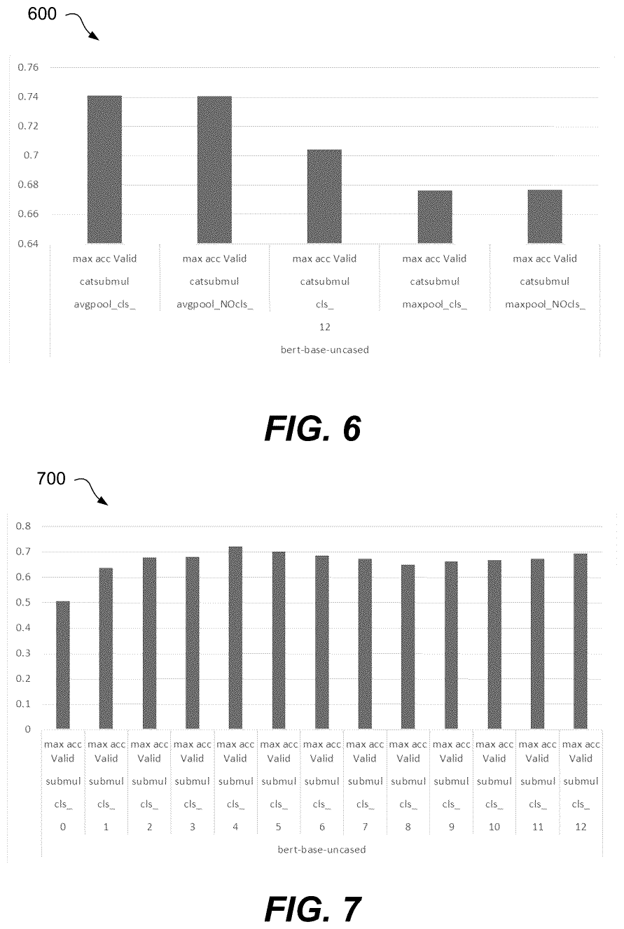

FIG. 6 depicts a graph 600 comparing pooling strategies for a given transformer model. Embedding vectors were generated using a bert-base-uncased model and features extracted using catsubmul from layer 12. Different pooling strategies of avgpool_cls, avgpool_NOcls, cls, maxpool_cls, and maxpool_NOcls were compared. As seen in the graph 600, different pooling strategies have significant effect on the quality of model performance (i.e. the quality of the embedding vectors).

FIG. 7 depicts a graph 700 showing the effect of extracting embedding vectors from different layers of a given transformer model. The embedding vectors were generated using a bert-base-uncased model and extracted from different layers (0 to 12), with only the embedding representation of the CLS token extracted at each layer and submul feature engineering applied. As seen in the graph 700, extracting embedding vectors from different layers of the transformer model produces different accuracy.

Accordingly, the embedding quality evaluation as described above advantageously provides software developers with a robust comparison of different models and strategies for extracting embedding vectors.

Further, it has been found that ensemble models often outperform application of a single model. As described below, this is also found to be true for ensemble text representations. As such, the systems and methods of evaluating natural language processing may further provide for automated identification of the best model combination and their ensemble configuration. The ensemble models may combine multiple types of models (e.g. a combination of topic modeling, SBERT, BERT, etc.). The use of ensemble models may raise a particular challenge in information retrieval use cases that in many applications have to adhere to sub-second latency. As such, in some applications it may be important to outperform accuracy with a combination of smaller models vs application of a larger model in order to meet cost and latency objectives.

In accordance with the present disclosure, three architectures are described that may be used to generate an ensemble model of embedding vectors that could perform better than any single model that it is composed of.

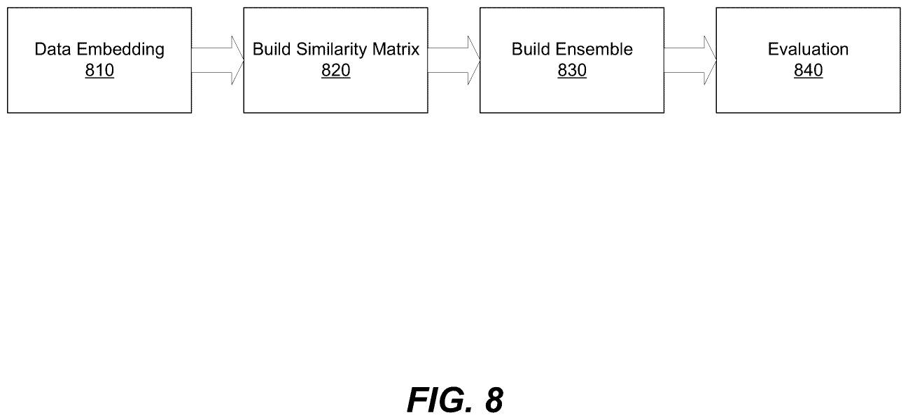

FIG. 8 depicts an example flow chart of a first ensemble architecture. In this first ensemble architecture, a weighted ensemble model is generated. Generating the weighted ensemble model generally comprises: (i) re-using the encoder and pre-processing parts of the model evaluation pipeline to convert data into their embedding representations; (ii) converting the embedding representations of the data pairs into similarity data by calculating the similarity between each embedding representation output from individual models and combining the results; (iii) applying a neural network model trained to learn the weights of each transformer model in the first ensemble architecture; (iv) using a semantic search retriever which could use different combinations of models to retrieve the relevant outputs for a given input; and (v) using an evaluator module to evaluate both individual and ensemble models. Overall, there may be two stages of evaluation. In the first evaluation stage a series of classification measures such as Accuracy, F1 scores, Area under Curve (AUC), etc. are used to pick a series of models (e.g. as described above). For generating an ensemble model and learning weights for the first ensemble architecture, the primary benchmark used is Information Retrieval (IR) benchmarks. However, different types of metrics such as MRR, accuracy, etc., are used. Therefore, as part of the pipeline the combination of the two types of evaluation measures may be used and the evaluation measures, like the data pairs, are often task specific i.e., there is a different strategy chosen to pair and do sampling for classification versus information retrieval versus response recommendation. The combination of the above selection and metrics provides a comprehensive evaluation of the embedding models.

The flow chart of the first ensemble architecture shows four stages: a data embedding stage 810, a building similarity matrix stage 820, a building ensemble stage 830, and an evaluation stage 840.

In the data embedding stage 810, data pairs are converted into their embedding representations using different NLP models, as described at data embedding stage 320 in the flow chart shown in FIG. 3.

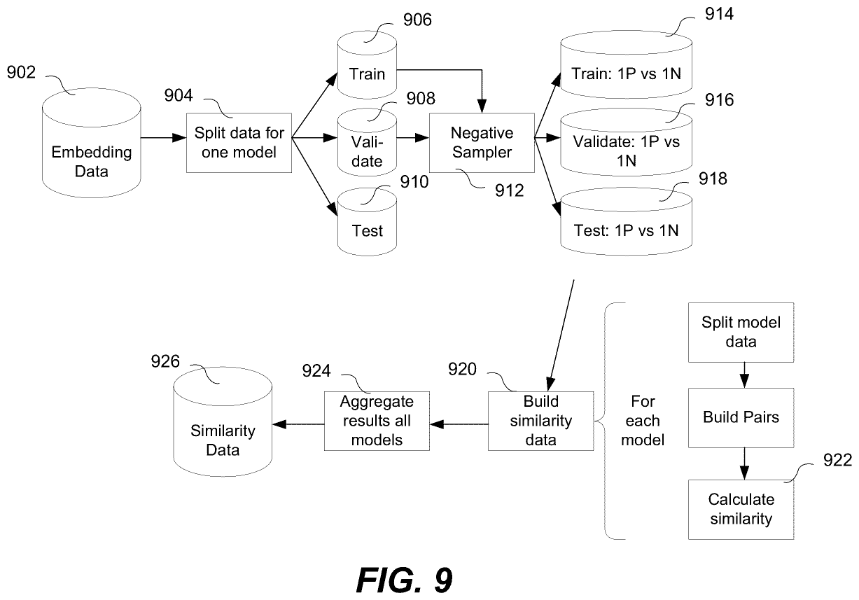

The building similarity matrix stage 820 comprises building a similarity matrix, as further shown in FIG. 9, which depicts an example flow chart for building a similarity matrix. As seen in FIG. 9, embedding data 902 output from the data embedding stage 810 is split for each model (904) into training (906), validation (908), and test (910) datasets. A negative sampler 912 is applied to generate positive and negative sample data pairs for the training (914), validation (916), and test (918) datasets. Similarity data is built for each model (920) by calculating a cosine similarity between embedding representations of each pair of data generated by different models (922). The similarity for all models is aggregated (924) and stored as similarity data 926. For example, the similarity matrix may have a column that shows whether pairs are a positive sample or a negative sample. If they are positive the value is 1 otherwise its zero. Also, there is a column for each model in the similarity matrix which the values are between 0 to 1 referring to the cosine similarity scores calculated by the embedding vectors of that particular model.

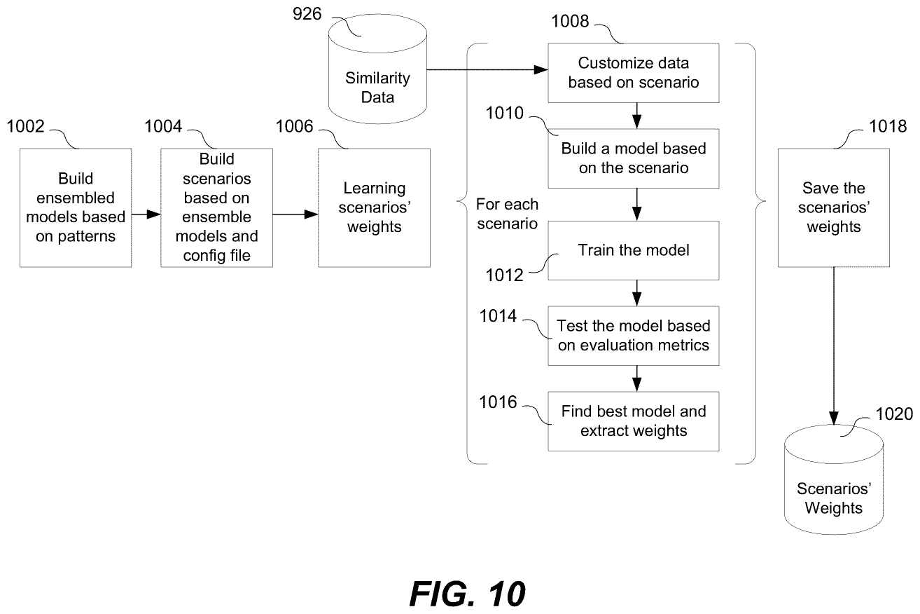

Referring back to FIG. 8, build ensemble stage 830 comprises building ensemble models, as further shown in FIG. 10, which depicts an example flow chart for building ensemble models. First, different ensemble models are generated based on defined patterns (1002). For example, a defined pattern may be a combination of all available models, a user defined pattern (e.g. a user can define which models to combine in the configuration files), etc. A neural network is used to learn how to combine the specified models for each scenario (pattern). To do that, first the specified models in a scenario are combined (1004). Then a neural network (e.g. a perceptron) is employed to learn the weights for combining different models in a scenario (1006) by learning the importance of each model in the ensemble model and assigning the higher weights to the better models. The input to the neural network is the similarity data 926 as described above with scores of input pairs computed by each model and the output is whether the input pairs are matched or not. For each scenario (i.e. ensemble model), the similarity data is customized based on the scenario in a way that only the columns related to the models existing in the ensemble model are used (1008). A model is built based on the scenario (1010) and the model is trained using the training data (1012). The model is tested using validation data and evaluated using metrics (1014) to choose the best weights. The best model and weights are determined (1016). After training, the corresponding weight of each input of the neural network is the weight of the model from which that input was obtained. The weights of the neural network that is trained for each scenario are extracted and saved (1018) and stored as scenarios' weights 1020, and used to aggregate the results of the single models in the ensemble model.

Referring back to FIG. 8, evaluation stage 840 comprises running an evaluator module that can evaluate both individual and ensemble models in terms of the IR evaluation metrics used (i.e., Acc@K, MRR). As previously described, applying an IR benchmark in addition to other evaluation measures (e.g. clustering benchmarks) that were applied in earlier stages of the evaluation would cover breadth and depth for evaluation. If the use case is a pure classifier, then one could change the approach slightly and use something similar to the embedding selection for this stage as well. However, the IR benchmark can be used for all use cases.

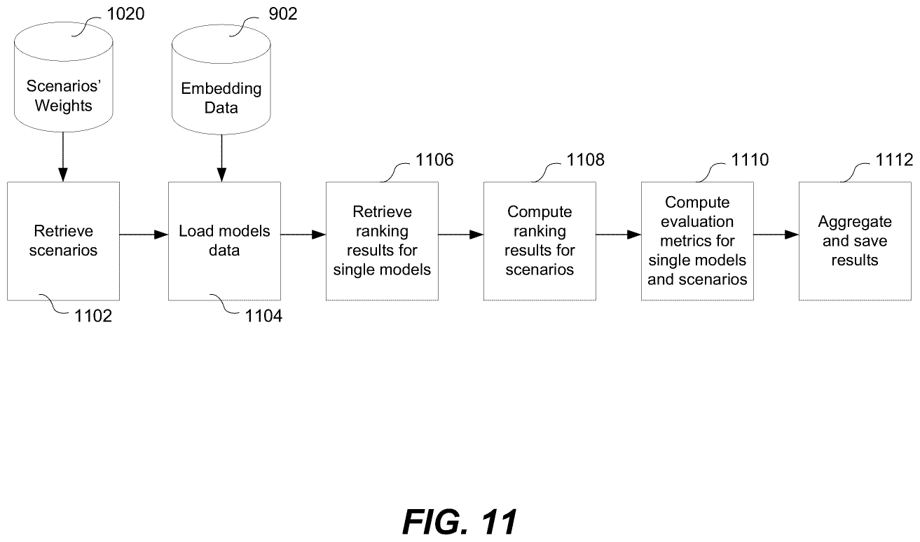

A vector database search engine can use different combinations of models to retrieve the relevant results to the inquiry. FIG. 11 depicts an example flow chart implemented by the evaluator module. Scenarios are retrieved (1102) from the scenarios' weights 1020. Model data is loaded (1104) from the embedding data (902). Ranking results are retrieved for single models (1106). Ranking results are computed for the scenarios (1108). Evaluation metrics are computed for both the single models and the scenarios of the ensemble models (1110). The evaluation results are aggregated and saved (1112).

An example of generating and evaluating an ensemble model is now described. In this example, five well-known SBERT models are used: (1) all-distilroberta-v1, (2) multi-qa-mpnet-base-dot-v1, (3) paraphrase-albert-small-v2, (4) all-MiniLM-L12-v2, and (5) paraphrase-multilingual-mpnet-base-v2. The test data set contained 15,381 question and answer pairs from a question and answer pair database. The evaluation task is to find the correct answer for each incoming inquiry among the 15,381 available answers in the test set.

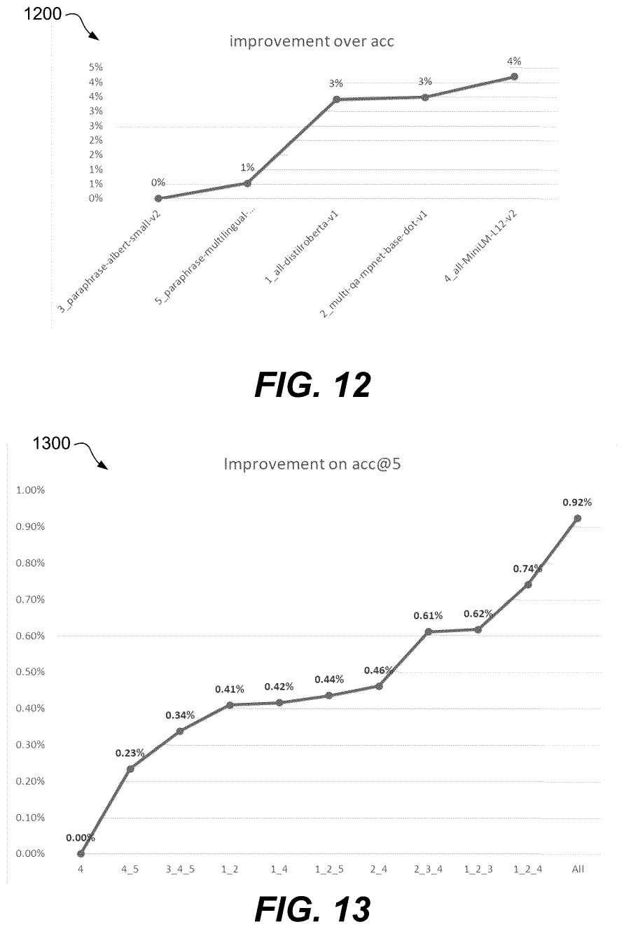

From the evaluation process of single models, it is determined that the worst model in terms of the accuracy is paraphrase-albert-small. The performance of other models relative to the worst performing model (i.e., paraphrase-albert-small-v2) is evaluated in terms of the accuracy, and shown in the graph of FIG. 12, which depicts a graph 1200 showing improvements in accuracy between different models. As seen in the graph 1200, the models are performing differently, providing the insight that simply by changing the model used in a given application, the performance of the system can be improved without making any changes to code.

As new models are emerging, the best model that was used in the past may not still be the best available option. The NLP SDK also allows for monitoring the state-of-the-art models and test them on specific use cases. If the new model is better, it can provide a recommendation to use the new model instead. For example, by replacing paraphrase-albert-small-v2 with all-MiniLM-L12-v2, the accuracy of the model performance can be improved by 4%.

A comparison between ensemble models and the best single model (i.e., all-MiniLM-L12-v2) shows the ensemble architecture of models could further improve the result. This is important since several models can easily be combined together to make an ensemble of them and improve the performance of the application.

FIG. 13 depicts a graph 1300 showing improvement on acc@5 of different combinations of ensemble models relative to the best single model (i.e., all-MiniLM-L12-v2). Although the combination of all models has the best performance in FIG. 13, the combination of models 1, 2, and 4 has a close performance to all. As the computational resources may be limited and latency is important in some applications, it's important to determine which two or three models can be used instead of using a combination of all models that may have the similar accuracy but operates faster. The SDK could help by recommending the best ensemble of two or three models.

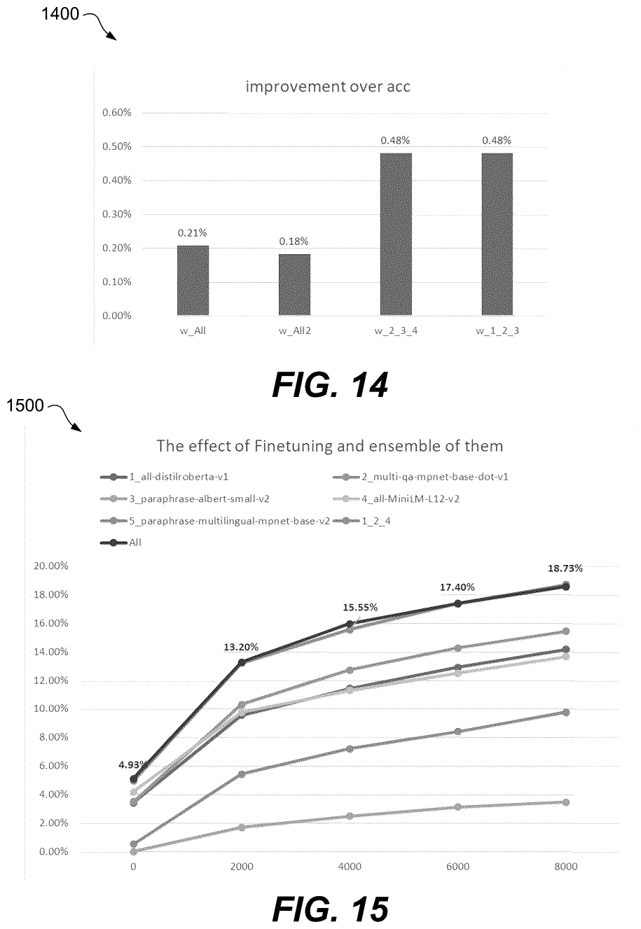

As described above, a neural network may be used to learn how to combine the models in an ensemble model. With reference to the Table below, c_All denotes an ensemble model that the weights of all its single models are equal (i.e., equal to one), while w_All and w_All2 are two ensemble models with their weights determined by a neural network. The neural network was used to build two ensembles, i.e., w_All and w_All2, to investigate whether the learned weights are consistent on different runs or not. As seen in the Table, the learned weights for the models in both ensembles are consistent. As seen in the Table, the neural network correctly recognized that all_MiniLM-L12-v2 is the best model on this use case, therefore, this model was assigned the highest weight making it the most important model in the ensemble model. On the other hand, the neural network recognized that paraphrase-multilingual-mpnet-base-v2 is the worst model, assigning a very low value to it to remove it from the ensemble as it is not as useful as other models in the ensemble model. FIG. 14 depicts a graph 1400 showing how learning weights by a neural network could improve the result compared to an equal-weighting approach. For example, as seen in FIG. 14, the weight learning approach could improve the result of equal-weighting approach by 0.48 for the ensembles 1_2_3 and 2_3_4.

| model | id | w_All | w_All2 | c_All |
|---|---|---|---|---|
| all-distilroberta-v1 | 1 | 1.72133005 | 1.65320253 | 1 |
| multi-qa-mpnet-base-dot-v1 | 2 | 3.23196912 | 3.18441463 | 1 |
| paraphrase-albert-small-v2 | 3 | 0.69273818 | 0.67372358 | 1 |
| all-MiniLM-L12-v2 | 4 | 4.82800007 | 4.94128752 | 1 |
| paraphrase-multilingual- | 5 | 0.001 | 0.001 | 1 |
| mpnet-base-v2 | | | | |

The base models were fine-tuned on 2k, 4k, 6k, and 8k of data to investigate how fine-tuning can improve the results. For example, the models may be fine-tuned on a train portion of the data using MultipleNegativesRankingLoss technique (https://arxiv.org/pdf/1705.00652.pdf), however this approach could also be changed in the configuration file by users. For the fine-tuning, it was investigated how using more data would lead to increase the accuracy of the models. For this purpose, separate experiments were conducted having 2k, 4k, 6k, and 8k of training data and then compare the performance of the fine-tuned models on the test portion of our dataset. It is worth noting that, there is an overlap between the 2k, 4k, 6k, 8k sets. For example, the 6K training set contains the whole data of 4K along with another 2K samples of data.

FIG. 15 depicts a graph 1500 showing the performance of the base, fine-tuned, and ensembles relative to the worst model (i.e., paraphrase-multilingual-mpnet-base-v2). A number of observations can be seen. First and foremost, fine-tuning can improve the performance of all the single models. So, if the data is available, the available data should be leveraged to fine-tune the models for use-cases. Secondly, the more data available for fine-tuning the better the performance of the models are. However, as the amount of data increases, the slope of improvement decreases. Thirdly, an ensemble model of the fine-tuned models is better than each individual fine-tuned model by far. Fourthly, a fewer number of models can still be found in an ensemble model but have a similar performance to the ensemble of all models (e.g. 1_2_4 vs All in FIG. 15). Last but not least, the ensemble of fine-tuned models on 2K data is still better than any single model that is fine-tuned on 8k of data. This is an important finding as in some use-cases there might not be much available data for fine-tuning. In these cases, ensemble of fine-tuned models could compensate the lack of data since it is competitive with the fine-tuned models on a bigger size of data. Also, fine tuning 3 models with 2K data often requires significantly lower computational resources and is cheaper to do on an ongoing basis.

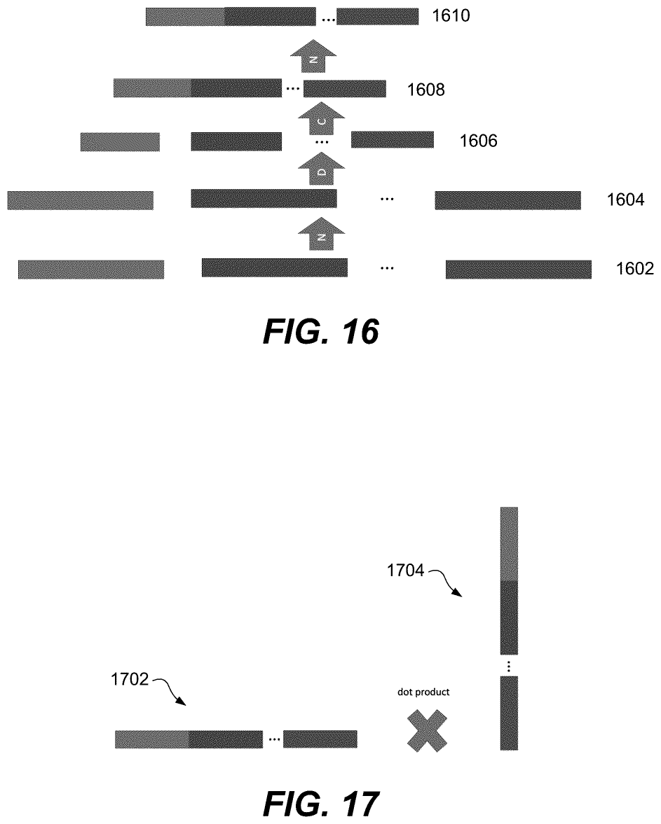

A second architecture for generating an ensemble model of embedding vectors is now described. FIG. 16 depicts a representation of the embedding vectors output from different models being combined with the second architecture. In this approach, the positive and negative data pairs (e.g., positive and negative Question and Answer pairs) are first converted into their embedding representations using each model separately as represented at 1602. As the model's architectures are different, the distribution of the generated embeddings would also be different. For example, the output of one model may not be normalized while the other one is normalized. To address this, the values of each embedding vector are normalized separately as represented at 1604. One problem is that the model with the bigger embedding vector would have higher influence on the result. To address this, the size of the models' embedding vectors are made the same size by performing dimensionality reduction as represented at 1606. However, limits may be imposed to not make any embedding representation smaller than a threshold value (e.g. 384) to ensure the vector does not lose context. An ensemble embedding vector is built by concatenating all the normalized embedding vectors as represented at 1608. The ensemble embedding vector is also normalized as represented at 1610.

After applying the above stages, there is one normalized ensemble embedding for each pair of data. To calculate the similarity between each of the data pairs, the dot product is calculated between corresponding ensemble embedding vectors. It is not necessary to apply cosine similarity as both ensemble vectors are normalized (i.e., as the length of the vector is equal to one, the denominator of the cosine similarity function is equal to one).

It is worth noting that by applying the dot product between the two ensemble embedding vectors, only the scalar values that are generated by the same model would be multiplied together. FIG. 17 depicts a representation of the dot product between two ensemble embedding vectors 1702 and 1704. This second architecture for generating an ensemble model of embedding vectors provides a simple approach to generating the ensemble model. However, one potential drawback is that the model with the bigger embedding vector would have higher influence on the result. To address this, it may be prudent to make the size of the models' embedding vectors the same size.

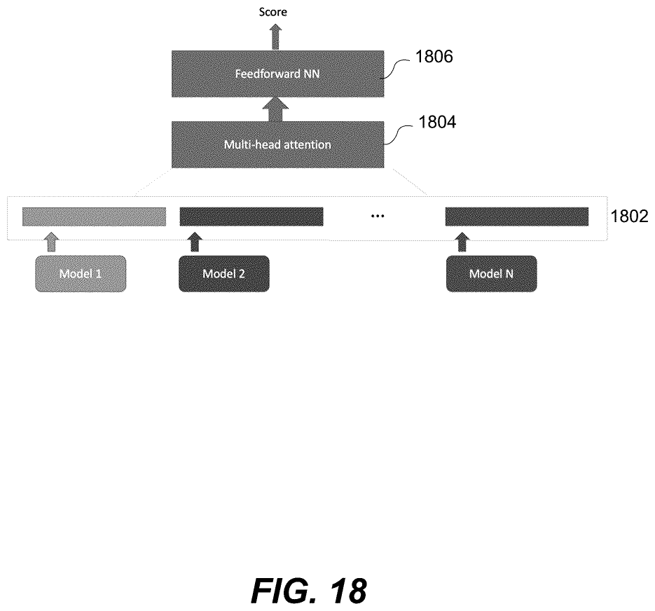

A third architecture for generating an ensemble model of embedding vectors is now described. FIG. 18 depicts a representation of the embedding vectors output by from different models being combined with the third architecture. The third architecture comprises converting embedding vectors generated by each model into a feature vector using multiplication as represented at 1802. Then, as it is shown in FIG. 18, the feature vectors are then combined and fed into a multi-head attention network 1804. The multi-head attention network may be similar to that being used in the transformer architecture by Vaswani et al., Attention is All You Need (arXiv:1706.03762). Each head is simply a linear transformation that applies on the embedding vectors of each sequence of data. Each attention head would learn how to focus the attention to different parts of the generated embedding vectors of the model. For each attention head, the K, V, and Q matrices would be trained during the training process. The number of heads is equal to the number of models as each head would be applied only on the output of one model. The size of each head would also be different as the size of the models used may be different from each other. Also, the sequence length of input data is always equal to one. That means the input to each attention head is a vector of size d (d is the size of the embedding) since the sequence length is equal to one. In the end, the output of each attention head would be concatenated together. The feed forward neural network 1806 is trained to learn how to leverage the embeddings generated by the model to produce a similarity score between 0 and 1. This approach is slower than the other approaches. Therefore, if performance is an issue, this approach could be used as a re-ranker. In that scenario, an ensemble model created by the first or second architectures could be used to retrieve the top N most similar samples. Then these top K samples are then fed into the ensemble architecture to obtain the top K results (K<<N). Instead of a multi-head attention layer, a deep fully connected layer may be used.

FIG. 19 depicts a method 1900 of evaluating natural language processing models in accordance with the present disclosure.

The method 1900 comprises obtaining a dataset for a particular application comprising a plurality of data pairs (1902). Obtaining the dataset may comprise generating the dataset comprising positive and negative data pairs by: receiving a sample dataset comprising unlabelled sample data; and generating positive and negative data pairs from the sample dataset.

The sample dataset may comprise sample data pairs, and generating the positive data pairs from the sample dataset comprises labelling received sample data pairs as positive data pairs, and generating negative data pairs from the sample dataset comprises generating a negative output for a respective input by one or more of: randomly generating the negative output by picking a random output from the data set for the respective input, where an identifier of the random output and the respective input are different; randomly choosing an output for the respective input, calculating a topic vector for the output and the respective input, and selecting the output as the negative output for the respective input when the topic vectors are not equal; and randomly choosing an output for the respective input, calculating a cosine similarity of the output and the respective input, and selecting the output as the negative output for the respective input when the cosine similarity is less than a threshold.

Alternatively, the sample dataset may comprise non-paired input data, and generating the positive and negative data pairs comprises determining clusters of output data for a respective input, and determining positive and negative outputs for the respective input from the clustering analysis.

The method 1900 further comprises applying the plurality of data pairs to each of a plurality of natural language processing models (1904), wherein each of the plurality of natural language processing models outputs respective embedding representations of the plurality of data pairs.

The respective embedding representations of the plurality of data pairs may comprise embedding representations generated by different pooling strategies of a same natural language processing model.

The respective embedding representations of the plurality of data pairs may comprise embedding representations output by different layers of a same natural language processing model.

The method 1900 further comprises classifying the respective embedding representations of the plurality of data pairs output from each of the plurality of natural language processing models using a classifier trained to classify the data pairs (1906). The dataset may be split into training data, validation data, and test data, wherein the training data and the validation data are used for training the classifier. In some embodiments, the classifier is a weak classifier.

The method 1900 may further comprise extracting features from the embedding representations of the plurality of data pairs for performing the classification, the extracting comprising one or more feature extraction methods selected from: concatenating the embedding vectors for each data pair; multiplying the embedding vectors for each data pair; subtracting the embedding vectors for each data pair; concatenating and multiplying the embedding vectors for each data pair; concatenating and subtracting the embedding vectors for each data pair; concatenating and subtracting and multiplying the embedding vectors for each data pair; and subtracting and multiplying the embedding vectors for each data pair. Classifying the respective embedding representations of the plurality of data pairs may be performed using different feature extraction methods from the same respective embedding representations.

The classification results of the classifier on the respective embedding representations of the data pairs output from each of the plurality of natural language processing models are compared to evaluate the plurality of natural language processing models for the particular application (1908).

The method 1900 may further comprise generating an ensemble model of embedding vectors generated from the embedding representations of the plurality of data pairs output from each of the plurality of natural language processing models (1910).

In some embodiments, generating the ensemble model of embedding vectors may comprise using a neural network that determines weights for combining the plurality of natural language processing models.

In some embodiments, generating the ensemble model of embedding vectors comprises: normalizing each of the embedding representations of the plurality of data pairs output from each of the plurality of natural language processing models; building an ensemble embedding vector by concatenating the normalized embedding representations from a respective natural language processing model; and calculating the similarity of the embedding representations output from different natural language processing models by calculating the dot product between corresponding ensemble embedding vectors.

In some embodiments, generating the ensemble model of embedding vectors comprises: converting the embedding representations of the plurality of data pairs generated by each transformer encoder model into a feature vector using multiplication; combining the feature vectors; and providing the combined feature vectors to a multi-head attention network.

As part of the method 1900, a configuration file may be received that specifies parameters used in the evaluation of the natural language processing models.

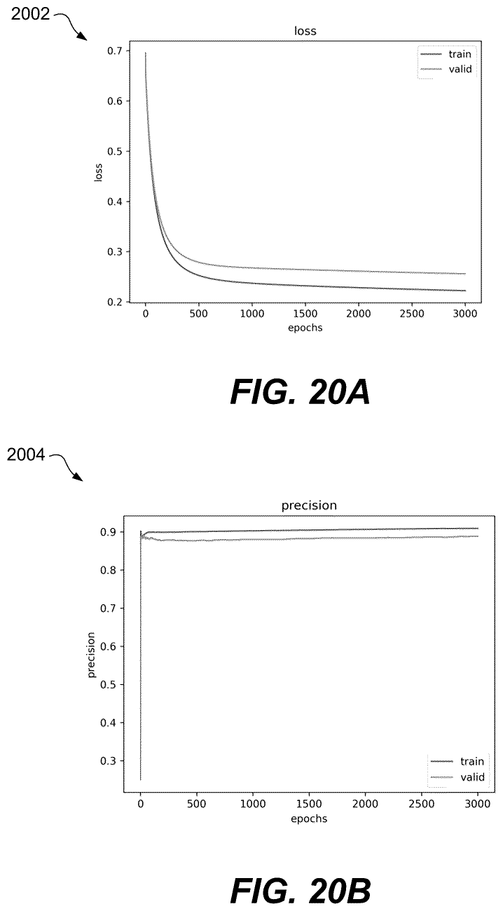

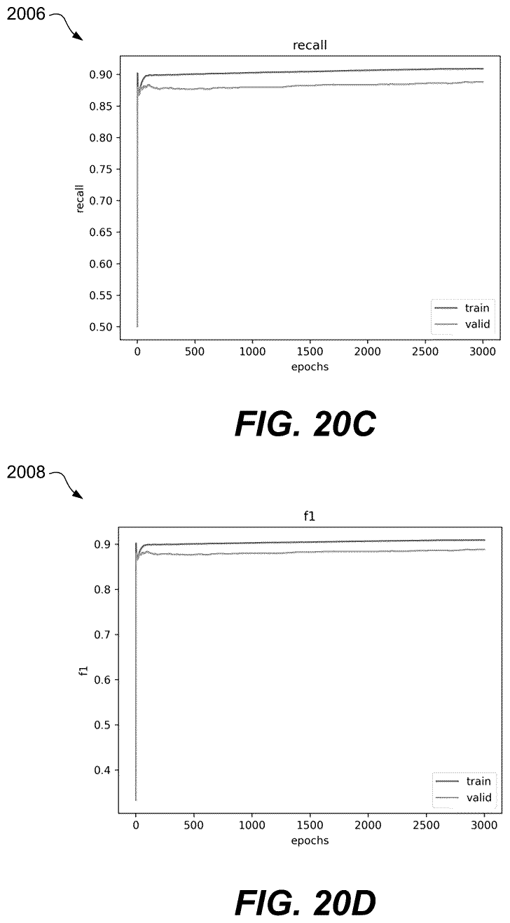

As described previously, the SDK can also provide detailed reports of the training part of the models, so that advanced users can ensure that the models are trained effectively, and/or for debugging purposes. For example, in training the weights for the ensembles according to the first ensemble architecture, the SDK may generate the charts 2002, 2004, 2006, and 2008 respectively shown in FIGS. 20A-D for loss function (FIG. 20A), precision (FIG. 20B), recall (FIG. 20C), and f1 score (FIG. 20D), where the line for validation data appears as a lighter shade in greyscale and the line for training data appears as a darker shade in greyscale.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method of evaluating natural language processing models, comprising:
obtaining a dataset for a particular application comprising a plurality of data pairs;
applying the plurality of data pairs to each of a plurality of natural language processing models, wherein each of the plurality of natural language processing models outputs respective embedding representations of the plurality of data pairs;
classifying the respective embedding representations of the plurality of data pairs output from each of the plurality of natural language processing models using a classifier trained to classify the data pairs; and
comparing classification results of the classifier on the respective embedding representations of the data pairs output from each of the plurality of natural language processing models to evaluate the plurality of natural language processing models for the particular application.

2. The method of claim 1, further comprising generating the dataset comprising positive and negative data pairs by:
receiving a sample dataset comprising unlabelled sample data;
generating positive and negative data pairs from the sample dataset.

3. The method of claim 2, wherein the sample dataset comprises sample data pairs, and wherein generating the positive data pairs from the sample dataset comprises labelling received sample data pairs as positive data pairs, and generating negative data pairs from the sample dataset comprises generating a negative output for a respective input.

4. The method of claim 3, wherein generating the negative output for the respective input comprises:
randomly generating the negative output by picking a random output from the data set for the respective input, where an identifier of the random output and the respective input are different.

5. The method of claim 3, wherein generating the negative output for the respective input comprises:
randomly choosing an output for the respective input, calculating a topic vector for the output and the respective input, and selecting the output as the negative output for the respective input when the topic vectors are not equal.

6. The method of claim 3, wherein generating the negative output for the respective input comprises:
randomly choosing an output for the respective input, calculating a cosine similarity of the output and the respective input, and selecting the output as the negative output for the respective input when the cosine similarity is less than a threshold.

7. The method of claim 2, wherein the sample dataset comprises non-paired input data, and generating the positive and negative data pairs comprises determining clusters of output data for a respective input, and determining positive and negative outputs for the respective input from the clustering analysis.

8. The method of claim 1, further comprising splitting the dataset into training data, validation data, and test data, wherein the training data and the validation data are used for training the classifier.

9. The method of claim 1, wherein the respective embedding representations of the plurality of data pairs comprise embedding representations generated by different pooling strategies of a same natural language processing model.

10. The method of claim 1, wherein the respective embedding representations of the plurality of data pairs comprise embedding representations output by different layers of a same natural language processing model.

11. The method of claim 1, further comprising extracting features from the embedding representations of the plurality of data pairs for performing the classification, the extracting comprising one or more feature extraction methods selected from:
concatenating the embedding vectors for each data pair;
multiplying the embedding vectors for each data pair;
subtracting the embedding vectors for each data pair;
concatenating and multiplying the embedding vectors for each data pair;
concatenating and subtracting the embedding vectors for each data pair;
concatenating and subtracting and multiplying the embedding vectors for each data pair; and
subtracting and multiplying the embedding vectors for each data pair.

12. The method of claim 11, wherein classifying the respective embedding representations of the plurality of data pairs is performed using different feature extraction methods from the same respective embedding representations.

13. The method of claim 1, wherein the classifier is a weak classifier.

14. The method of claim 1, further comprising generating an ensemble model of embedding vectors generated from the embedding representations of the plurality of data pairs output from each of the plurality of natural language processing models.

15. The method of claim 14, wherein generating the ensemble model of embedding vectors comprises using a neural network that determines weights for combining the plurality of natural language processing models.

16. The method of claim 14, wherein generating the ensemble model of embedding vectors comprises:
normalizing each of the embedding representations of the plurality of data pairs output from each of the plurality of natural language processing models;
building an ensemble embedding vector by concatenating the normalized embedding representations from a respective natural language processing model; and
calculating the similarity of the embedding representations output from different natural language processing models by calculating a dot product between corresponding ensemble embedding vectors.

17. The method of claim 14, wherein generating the ensemble model of embedding vectors comprises:
converting the embedding representations of the plurality of data pairs generated by each transformer encoder model into a feature vector using multiplication;
combining the feature vectors; and
providing the combined feature vectors to a multi-head attention network.

18. The method of claim 1, further comprising receiving a configuration file that specifies parameters used in the evaluation of the natural language processing models.

19. A system for evaluating natural language processing models, comprising:
a processor; and
a non-transitory computer-readable medium having computer-executable instructions stored thereon which, when executed by the processor, configure the system to perform a method of evaluating natural language processing models, comprising:
obtaining a dataset for a particular application comprising a plurality of data pairs;
applying the plurality of data pairs to each of a plurality of natural language processing models, wherein each of the plurality of natural language processing models outputs respective embedding representations of the plurality of data pairs;
classifying the respective embedding representations of the plurality of data pairs output from each of the plurality of natural language processing models using a classifier trained to classify the data pairs; and
comparing classification results of the classifier on the respective embedding representations of the data pairs output from each of the plurality of natural language processing models to evaluate the plurality of natural language processing models for the particular application.

20. A non-transitory computer-readable medium having computer-executable instructions stored thereon which, when executed by a processor, configure the processor to execute a method for evaluating natural language processing models, comprising obtaining a dataset for a particular application comprising a plurality of data pairs;
applying the plurality of data pairs to each of a plurality of natural language processing models, wherein each of the plurality of natural language processing models outputs respective embedding representations of the plurality of data pairs;
classifying the respective embedding representations of the plurality of data pairs output from each of the plurality of natural language processing models using a classifier trained to classify the data pairs; and
comparing classification results of the classifier on the respective embedding representations of the data pairs output from each of the plurality of natural language processing models to evaluate the plurality of natural language processing models for the particular application.
